(19) United States
(12) Patent Application Publication
(10) Pub. No.: US 2003/0174131 A1
(43) Pub. Date: Sep. 18, 2003

(54) Instruction method to effect systemic reframing thinking

(76) Inventor: Zvi Lanir, Tel Aviv (IL)

Correspondence Address: Mark M Friedman, Bill Polkinghorn, Discovery Dispatch, 9003 Florin Way, Upper Marlboro, MD, 20772, US

(21) Appl. No.: 10/381,841

(22) PCT Filed: Nov. 8, 2001
(86) PCT No.: PCT/US01/43010

(51) Int. Cl. G06T 15/00

(52) U.S. Cl. 345/419

(57) ABSTRACT

A method and device of exposing, formulating and graphically displaying a mindset is disclosed. Once a mindset is exposed and displayed it can be confronted, criticized and modified with the help of the graphic display in a process known as reframing. After an issue is stated, a concept list is made. Using the concept list, a deliberation space map is generated, the deliberation map representing the mindset is graphically represented. The deliberation map is made of a plurality of deliberation spaces, constructs made of two concepts with a relationship of complementary negation when considered in the context of a third concept. A deliberation space map can be converged to generate a setting map as a preplanning stage for solving the challenge. A deliberation space map can be converged to form a knowledge map as a preservation of the knowledge in all its dynamic aspects. A knowledge map can be used for the presentation of conceptions and their transfer between individuals. A knowledge map can be used as the frame of reference in a discourse of knowledge development between individuals, groups and organizations.

### FIELD AND BACKGROUND OF THE INVENTION

The present invention relates to the field of instruction and, in particular, it concerns a method by which the adaptability of individuals, groups and organizations is increased by teaching the individuals, groups or organization to perform cognitive reframing, as well as a device to apply the method.

Individuals and organizations think using given mindsets. A mindset is an individual or organizational frame of reference wherein thought-processes, discussions and decisions are made. This meaning of the term “mindset” can be clarified by considering the case of an individual. The education and life experiences of a person in a large part define the individual's mindset. When the person encounters a challenge (an event, a problem or some such stimulus) the person reacts to-the challenge in a way that is in a large part determined by his mindset.

As is well known to one skilled in the art, under the influence of conventional upbringing and educational methods humans and groups of humans develop fixed mindsets. In the past, when the nature of challenges was relatively constant over time, this was not a serious problem. When revolutionary changes did happen, accepted mindsets were insufficient to formulate appropriate responses to these changes. The near anarchy in Russia as a result of the collapse of the Soviet Union is an example of such a revolutionary change. All levels of society, from the individual to large organizations were incapable of dealing with new challenges due to inappropriate mindsets and the lack of the ability to change the mindsets to deal with the new challenges.

Whereas in the past radical changes in the nature of challenges happened at a slow pace, in the modem world several dramatic changes may occur within the time of one generation. The rapid pace of change in the modem world, be it the personal situation of an individual or changing technology for an organization means that a mindset, which was successful by some standard, is quickly obsolete. Established organizations have difficulty in competing when challenged by new environments and dynamic competitors.

To overcome this problem, organizations have tried to integrate innovative management methods to make full use of available human resources and skills. By breaking the traditional hierarchy it was hoped to bring a wider spectrum of skills to bear on the challenges an organization faced. Such methods as excellence units, worker empowerment, matrix management structures or multidisciplinary teams have been implemented with, at best, mixed success.

The reason that no panacea has been found is that the basic problem remains the same: the mindsets which individuals and organizations use to cope with the challenges are fixed and change only slowly, if at all.

Reframing a mindset, that is, changing a mindset tinder influence of a challenge is natural to the human mind but is by no means a straightforward process. Mindset reframing is a complex cognitive process that is difficult for most people to perform.

Facing the increasing rate, variety and complexity of challenges which an individual, group or an organization encounter, the ability to reframe a mindset is a valuable and much needed asset. However, cognitive sciences have failed to provide tools necessary for systemically facilitating the ability to reframe mindsets.

There is thus a need for a method of instruction that teaches an individual, a group or an organization to reframe a mindset.

### SUMMARY OF THE INVENTION

The above and other objectives are achieved by the use of the method, and in particular by the use of the computer-based device provided by the present invention.

Hereinbelow the term “user” will be applied to the individual, group or organization that makes use of the method of the present invention. Although the singular is used, it is understood that user can refer to a plurality of individuals.

Hereinbelow the term “challenge” is used to refer to an external stimulus, such as a problem or event, which the user needs to relate or react to.

Hereinbelow the term “issue” is used to refer both to a challenge and to something less definite, for example, “what is the raison d'étre of the user” or “how can the environment in which the user operates be understood”.

The present invention is a method of instruction that can be applied to individuals, groups or organizations. The method of the present invention achieves two aims simultaneously.

The first overt aim is to help the user break through or to “reframe” a current mindset. The user recognizes that the current way of interpreting, understanding and reacting to challenges, based on the current mindset, is insufficient. For example, the user sees that continuous effort is spent in problem solving, without long-term or deep-rooted success. Therefore the user needs to discard the old ways of thinking and to generate a new mindset.

“Reframing a mindset is defined as the ability to systemically identify a mindset by breaking the mindset to its components and to the relationship between the components and thereafter creating a new mindset by criticizing the validity and examining the old mindset. The ability to identify and graphically represent the mindset given by the method of the present invention is unique and not taught in the prior art.

To this end, the mindset of the user is -organized and graphically displayed in a deliberation space map (D-Space map) during a brainstorming stage. In a following convergence stage, the mindset, as represented by the D-space map, is reorganized by with reference to or in the context of a challenge and graphically displayed in a setting map. This reorganization can be seen as a pre-planning stage leading to the actual addressing or treatment of a specific challenge. It is important to note that in the convergence stage the D-space map is also reviewed and examined to see if the mindset it represents suffices to address the specific challenge. If not, the D-space map is modified “on the fly” so that the mindset changes in order to be able to address the challenge.

The units that make up a D-space map are deliberation spaces (D-spaces). The nature of D-spaces is explained completely hereinbelow. In summary, a D-space is the tool by which a concept applicable to an issue is defined and understood. As opposed to a simple textual explanation most often used in the art to define concepts, a D-space delineates an individual concept within an appropriate context and according to the complementary negation (see below) which defines the concept. The use of D-spaces prevents the conventional linearity of thoughts and forestalls the indoctrination of non-systemic ideas.

The second, covert, aim of the present invention is to change the manner by which the user thinks. The underlying principle of the method is not that of cause and effect, but rather of “complementary negation”, developed by Heraclites and with which one skilled in the art is well acquainted. In short, Heraclites stated that there is a need of perceiving the whole as consisting of a tension between different yet complementary aspects. The whole cannot be dismantled into its distinct aspects without losing its distinctive systemic nature. Thus, an aspect describes a part of the whole only in the context of other aspects. The application of the principle of complementary negation by the method of the present invention will become apparent in the description hereinbelow. As the user is led to use the principle by the method of the present invention, the user is taught to think in a different way. Instead of thinking “systematically” (over all steps of a challenge one at a time) the user is taught to think “systemically”, that is of the challenge as one entity composed of many interacting and opposing parameters.

According to the teachings of the present invention there is provided a method for generating a D-space map by: a. formulating an issue; b. producing and maintaining a concept list; c. selecting three concepts, applicable to the issue, from the concept list; d. discussing the three selected concepts within a framework delineated by a D-space; and e. relating the D-space to at least one additional D-space, the at least one additional D-space pertaining to the issue.

There is also provided according to the teachings of the present invention a method of graphically representing a mindset by generating a D-space map and displaying the D-space map using a graphic display means (e.g. monitor or projector).

There is also provided according to the teachings of the present invention a method of graphically representing the concept of complementary negation between three concepts that describe an issue. Words or a term representing two of the concepts considered to have a complementary negation relationship are displayed using a graphic display means. Words or a term representing the third concept, which acts as the context in which the complementary negation is considered is displayed using the graphic display means in a way that is visually substantially different from the way that the first two concepts are displayed. According to a further feature of the present invention, a discussion concerning the negation between the first two terms in the context of the third term, and a summary of the discussion is displayed using the graphic display means.

There is also provided according to the teachings of the present invention a method of storing an idea by providing a storage means (e.g. hard disk or CD-ROM). A literal representation of the idea (i.e. as an issue) is stored in the storage means (for example as a sentence or phrase). A concept list relating to the idea is formulated and stored. A D-space map is generated from the concept list and when complete, the D-space map is stored.

There is also provided according to the teachings of the present invention a method of reframing a mindset by graphically representing the mindset using, a D-space map, systemically discussing the mindset by discussing the elements making up the D-space map, and when necessary, modifying the D-space map. The process of discussing and modifying the D-space map leads to reframing of the mindset.

There is also provided according to the teachings of the present invention,. a device configure to implement the methods of the present invention including a computer means (e.g. personal computer or personal digital assistant), an input means (e.g. a keyboard or computer mouse), a visual display means (e.g. a monitor or projector), and a series of computer instructions, the series of computer instructions configured to accept input from the input means,. display results through the visual display means and configured to perform at least one of the actions from the group including: i. displaying a concept list; ii. generating a D-space from a concept list upon instruction from a user; iii. forming a D-space map from a plurality of D-spaces; iv. graphically displaying a D-space map; v. forming a setting map from a D-space map; vi. graphically displaying a setting map; vii. transmitting (e.g. via electronic mail or the Internet) a setting map to a remote device; and viii. receiving a setting map from a remote device.

According to a further feature of the present invention, a method of storing knowledge is provided by using the device of the present invention to generate a setting map (knowledge map) representing the knowledge to be stored.

According to a further feature of the present invention, a method of instruction is provided by using the device of the present invention to display an appropriate setting map to at least one student, and instructing the at least one student by explaining the concepts appearing in the setting map.

According to a further feature of the present invention, participants (a single individual or a group of individuals) understand an issue of importance by using the device of the present invention to generate and display a D-space map. As the D-space map is displayed using the device of the present invention, the participants discuss the issue as represented by the D-space map, and when necessary modify it. The discussion of the issue as well as the process of modifying the D-space map that represents it necessarily leads to understanding of the issue.

According to a further feature of the present invention, participants (a single individual or a group of individuals) can make a decision concerning a challenge which is encountered by using the device of the present invention to generate and display a D-space map. A setting map, based on the D-space map, is generated. Based on the understanding gained from generating and contemplating the setting map, a decision can be made.

According to a still further feature of the present invention, a discussion of an issue between participants (at least two individuals) is facilitated with the help of the device of the present invention. A D-space map is generated and the issue is discussed using the framework provided by the D-space map. During the discussion the D-space map is modified as new knowledge and insights are gained. If desired or necessary, a setting map is generated based on the D-space map.

According to a still further feature of the present invention, a discussion of an issue between participants (at least two individuals) who are found in physically remote locations. A device of the present invention is accessible to participants at each one of the locations. In one of the locations a D-space map is generated and from the D-space map a setting map is generated. The setting map is transmitted (for example using such methods as electronic mail or the Internet) to the locations where the other participants are found. Independently, the participants display the setting map, discuss the setting map and if necessary generate a modified setting map based on the setting map. The modified setting maps are then transmitted to all of the other locations.

According to a further feature of the present invention, the individual mindsets of participants (at least two individuals) are unified with the help of the device of the present invention by generating a D-space map together and then discussing the D-space map. Still further, a setting map is generated based on the D-space map.

According to a still further feature of the present invention, the unity of a unified mindset can be maintained using the device of the present invention by displaying a D-space map representing the mindset, discussing the D-space map, and if necessary, modifying the D-space map Still further, a setting map is generated based on the D-space map.

According to a still further feature of the present invention, there is provided a method of noting an idea in order to use the idea at a later date, by using the device of the present invention to generate a D-space map, the D-space map describing the idea.

According to a still further feature of the present invention there is provided a method of storing a mindset using the device of the present invention by generating a D-space map representing the mindset.

### BRIEF DESCRIPTION OF THE DRAWINGS

The invention is herein described, by way of example only, with reference to the accompanying drawings, wherein:

FIG. 1 is a concept list related to the issue “Reframing”, as implemented in a preferred embodiment of the present invention;

FIG. 2 is a D-space of the present invention, made up of a triad of concepts, as implemented in a preferred embodiment of the present invention;

FIG. 3 is a D-space of the present invention with a description summarizing the results of a discussion concerning the complementary negation of two concepts, as implemented in a preferred embodiment of the present invention;

FIG. 4 is a D-space map of the present invention, as implemented in a preferred embodiment of the present invention;

FIG. 5 is a setting map of the present invention under preparation, wherein important concepts have been selected from a corresponding D-space map, as implemented in a preferred embodiment of the present invention; and

FIG. 6 is a setting map of the present invention integrating setting nap descriptions, as implemented in a preferred embodiment of the present invention.

### DESCRIPTION OF THE PREFERRED EMBODIMENTS

The principle of the method of the present invention may be better understood with reference to the description hereinbelow and the accompanying figures.

As described above, the method of the present invention is divided into two stages, brainstorming and convergence. Each stage is made up of a number of steps. For simplicity, the stages and respective steps are described hereinbelow serially. It is important to note that the method of the present invention is non-serial, and the user can perform any step of either stage at any time as deemed necessary.

In order to understand the method of the present invention, a preferred implementation of the present invention, as a computer-based device supporting a graphical input/output interface and processing software is described in parallel to the description of the method below.

First Stage: Brainstorming

The first stage of the method of the present invention is that of brainstorming where the mindset of the user is organized, rearranged and graphically displayed in a D-Space map Further, during brainstorming, the mindset of the user is extended, reconsidered and rearranged, by the process of brainstorming itself.

Step 1: Generating a Concept List

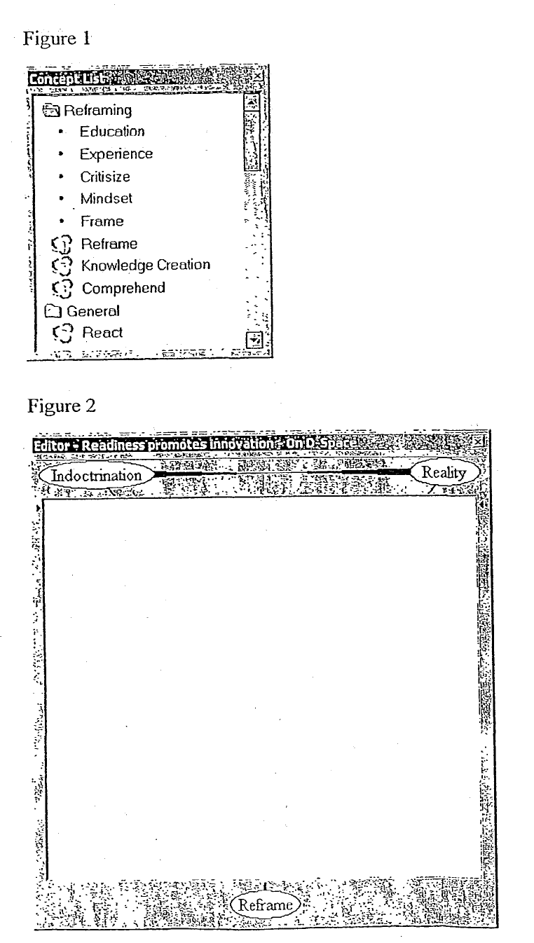

First, the user makes a concept list, a list of terms that are associative and evocative of concepts (aspects, influences, ideas) concerning a specific user-selected issue. An example of a concept list related to the issue “Reframing”, as implemented in a preferred embodiment of the present invention, is shown in FIG. 1.

Step 2: Opening D-Spaces

Once the concept list is sufficiently long, deliberation spaces (D-spaces) are opened. It is important to note that “sufficiently long” is arbitrary and is based on when the user wants to proceed to the following step. In each D-space a triad of concepts from the concept list as considered. Three concepts from the concept list are selected creating a D-space, FIG. 2. One concept (“Reframe”) is designated as the context, and the other two concepts (“indoctrination” and “reality”) are considered as having a complementary negation relationship between them in light of the context.

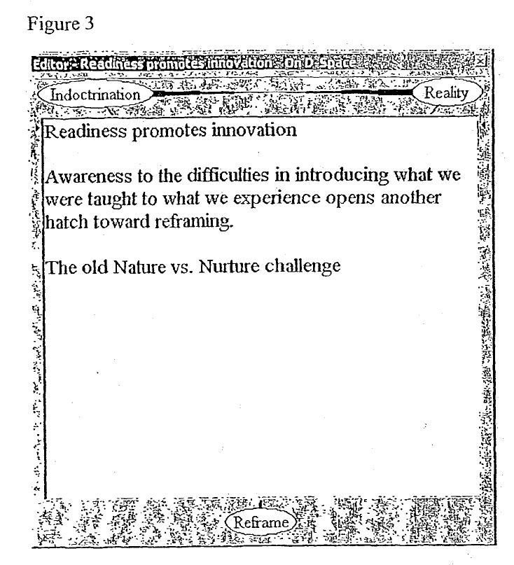

The meaning of associative discussion in this context is clear to one skilled in the art. It is important to note that unlike some associative discussions, during the associative discussion of the present invention a causal relationship is not sought, rather, the complementary negation within the triad is discussed. A description (as a phrase, a sentence, paragraph or essay) is written and annotated in the D-Space as part of the D-Space summarizing the results of the discussion. The user conducts an associative discussion about the meaning and significance of the triad, FIG. 3. In FIG. 3, the associative discussion produced a description that indicates that when considering the complementary negation of “indoctrination” vs. “reality”, one can consider the well-known nature vs, nurture challenge. It is necessary to be aware that what we are taught (“indoctrination”) is not necessarily applicable to what we experience (“reality”), and this awareness is a prerequisite for reframing. The readiness to be aware leads to the possibility of adapting to reality and producing innovation.

Each D-space contains only a triad of concepts. In this way the associative thinking necessary for implementation of the method of the present invention is focussed.

During the associative discussion and the writing of the description, additional concepts may be thought up and added to the concept list.

Step 3: Generation of a D-Space Map

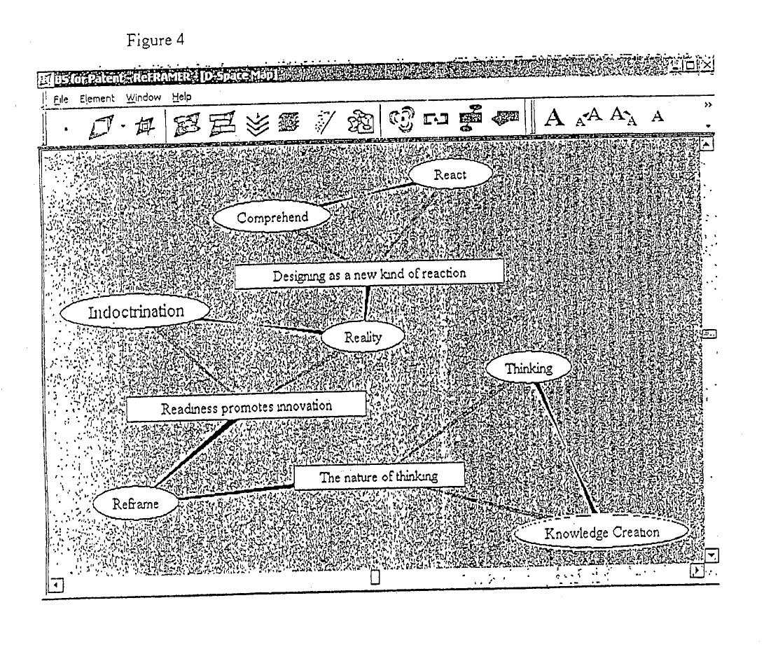

As the D-spaces are opened, the implementation of the present invention automatically arranges the individual D-spaces in a D-space map, a visual representation of the relationship between D-spaces. An example of a D-space map, as implemented in a preferred embodiment of the present invention, is shown in FIG. 4. Thus, the plurality of triads is graphically represented and displayed as an interconnecting network of concepts, called the D-space map. In FIG. 4, three triads make up the D-space map: “comprehend” vs. “react” in the context of “reality”; “indoctrination” vs. “reality” in the context of “reframing”; and “thinking” vs. “knowledge creation” in the context of “reframe”.

The generation of the D-space map has an overt and covert purpose. Overtly, the user is made aware of the concepts that define the mindset of the user. Once these concepts have been exposed and the user is aware of them, the concepts and the relationship between them can be changed and modified. Covertly, the exercise of discussing an issue using the principle of complementary negation teaches the individuals to think using complementary negation.

During the associative discussion, it often becomes apparent that an issue is not well addressed by existing concepts. Discussing the issue in the context of the concepts that already exist but are insufficient for formulating an acceptable decision will lead to the formulation of new concepts. When an issue is not well addressed by existing concepts, new concepts are formulated, added, to the concept list and then added to the D-space map in the framework of a triad through the use of a D-space. Once these new concepts are placed within the D-space map, they will become a part of the mindset of the user and can henceforth be applied to new challenge.

The D-space map helps the user see when the mindset is insufficient, and eases the generation of new concepts, expanding the mindset. The D-space map graphically presents the mindset so that it can be modified to meet a challenge.

Thick Preciseness

As is clear to one skilled in the art, as the concept list becomes longer and as the D-space map becomes more extensive, the user will develop the ability to describe and relate to every issue in more and more varied ways. As a result, every challenge will become more clearly defined by the mindset of the user. This point can be understood by considering the principle of “thick preciseness”. As is known to one skilled in the art, the human mind naturally works by association. That is, for a person to understand or describe some “thing”, the “thing” is related and compared to other things with which the person is acquainted. When only one association describes some “thing”, the “thing” is not clearly defined. When the “thing” is described using a multiplicity of associations it is more clearly defined. According to thick preciseness the intersection of a multiplicity of inaccurate associations will necessarily define some “thing” accurately.

Second Stage: Convergence Stage

The second stage of the method of the present invention is the convergence stage, performed by generating a setting map from the D-space map. The D-space map is reorganized, in the context of a challenge that needs to be addressed by the user, to generate a setting map. The D-space map is a graphic representation of the mindset of the user that is constructed with the help of a discussion concerning an issue. In contrast, the setting map is a graphic aid to help the user systemically discuss a challenge in the framework of the mindset. Parts of the D-space map, which are not applicable to the challenge, are removed or hidden. Concepts that are identical in the context of the challenge are united. Concepts are emphasized as a function of their importance to the challenge. The setting map is not modified as a result of discussions in a D-space. Rather the user considers how concepts relate to each other, and annotates a description discussing what the nature of the relationship is. In the setting map every entity, whether a concept or a connection between two concepts can have an associated description.

Step 1: Generating a Setting Map

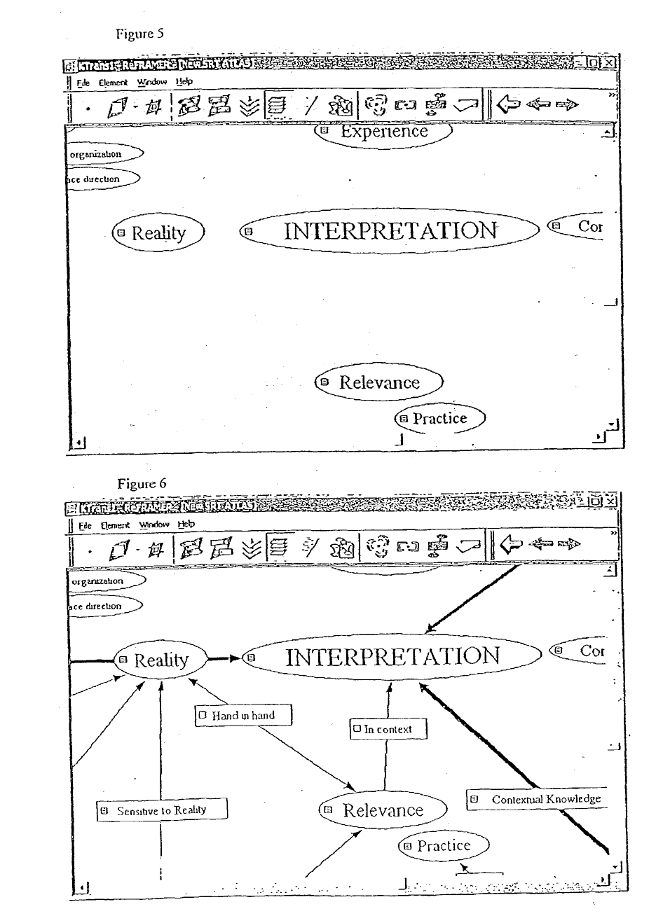

The first step in generating a setting map from a D-space map is the selection of a number of concepts from the D-space map that seem to be important in addressing the challenge for which the setting map is being produced, FIG. 5. In FIG. 5, concepts important in relating to a challenge are represented, where the relative size of each representation is in relation to the relative importance thereof.

Step 2: Formulating Setting Map Descriptions

The second step is to consider the descriptions corresponding to each of the chosen concepts and rewrite the descriptions so as to focus on the relation of each concept to the challenge being addressed. Excess or unnecessary text is erased and additional ideas are added to the description. In addition, each connection between two concepts is also discussed and a respective setting map description is formulated. At the end of this second step, each concept and each connection between two concepts in the setting reap has a setting map description detailing the relationship of the concept or connection to the challenge. An example of a setting map with setting map descriptions, as implemented in a preferred embodiment of the present invention, is shown in FIG. 6. In FIG. 6, the relationships between the different concepts in the setting maps are indicated with arrows, and accompanying each such relationship is a setting map description within a rectangular frame.

The generation of the setting snap can be considered a pre-planning stage, where the salient issues and knowledge applicable to a challenge are concentrated.

During the convergence stage, both the setting map and the D-space map are examined to see if the represented mindset suffices to relate to the specific issue. If not, the setting map and the D-space map are modified “on the fly” so that the mindset of the user is expanded in order to be able to relate to the issue.

Reframing the User Mindset

As is clear to one skilled in the art from the above discussion, the stages described hereinabove of the method of the present invention leads to a change of the manner by which the users thinks. Ordinarily, a challenge is treated systematically: it is divided into quanta, separate sub-challenges that are dealt with separately and serially, each sub-challenge by a limited number of people who are experts. Once all the sub-challenges have been addressed, the separate solutions of each sub-challenge are combined into one complete solution. Incongruities are glossed over or resolved through compromise. The basic relationship of each sub-challenge to a following sub-challenge is that of cause and effect.

When using the method of the present invention, the user is forced to consider the concepts of his mindset in the context of the whole challenge, and the whole challenge in the context of his mindset. There is no necessary causal relationship between things, rather in the context of one concept, there is some balance between any two other concepts. This is the principle of complementary negation. As a result the user is taught to think “systemically”, that is of the issue as a whole with many interacting parameters that must be considered simultaneously.

Uses of the Present Invention

It is also clear to one skilled in the art, that when the user represents a plurality of individuals, the method of the present invention helps define a common language with which to discuss issues.

The use of the method of the present invention ultimately increases the adaptability of a user in a rapidly changing environment, discussed in the introduction, above. Every new challenge is discussed and put into the context of the mindset of the user. As soon as the user is made aware that some aspect of a new challenge is not adequately treated by the mindset of the user, the user formulates new concepts that allow the challenge to be addressed rather than to apply existing but insufficient concepts.

The Use of the Present Invention in Improving Communication within an Organization

A specific field where the method of the present invention may be applied is within an organization. It is well known that in a large organization where one person represents, for example, sales, and another research and development, each individual may have a different mindset. Identical terms may not represent exactly the same concept. By using the present invention, a coherent language is developed which becomes accessible to the user as a whole. Not only does it allow individuals to effectively communicate through clearly defining a common vocabulary, it also allows for the creation of new insights, acting as a vehicle with which individuals with disparate experiences and knowledge can pass their view onto other individuals in a clear and understandable way. New insights and knowledge are also created in areas which are often ignored or insufficiently examined due to the interdisciplinary or multidisciplinary nature of in what is known in the art as the no-man cognitive zones.

Further, the use of triads and D-spaces in directing and structuring a discussion allows the participants to concentrate on specific aspects of a challenge without losing the “big picture”.

Discussion and debate management is eased. First, a common language is defined. Individuals must carefully consider what is said to conform to the discussion. Instead of arguing, individuals state their view on any aspect of an issue. Since their view is clearly defined within the framework of the D-space map, non sequiturs are immediately identified as such whereas new and revolutionary concepts are not dismissed out of hand.

Thus in such an organizational settling, the method of the present invention facilitates appropriate decision making, by supplying decision makers with all the knowledge necessary in an easy to understand and unambiguous way.

The Use of the Present Invention in Facilitating Mergers

In a different embodiment, the present invention is applied to overcome the challenges associated with the merger of two companies. Although objective economic considerations dictate that a given merger should succeed, differences in organizational or individual mindset often guarantee failure. Even if an effort is made for compromise, failure occurs. This is because compromise is based on a give and take that may be fair and equitable, but as the individuals still have a different mindset, further conflict is only temporarily averted. By applying the method of the present invention to a merger, the process of generating a D-space map followed by generating a setting map allows the definition of a common mindset.

In analogy, an additional embodiment of the present invention facilitates bridging and mediation. Often two organizations or individuals have a conflict, which seems irreconcilable. Methods known in the art lead to compromise, which as described herein above most often leads to a bad solution, one that is optimal for neither party and leads both unsatisfied. The use of the present invention allows for the clarification of misunderstandings and allows common ground to be found.

The Use of the Present Invention in Personal Relationship Therapy

A related application of the present invention is in the field of personal relationships. As is known to one skilled in the art, an oft stated reason for dissolution of a relationship or request for professional assistance (e.g. marriage counselling) is stated as the lack of ability to communicate. The colloquial “you must understand what I mean not what I say” expresses this lack of communication. The lack of communication often arises from the different backgrounds and expectations of the individuals of the couple. This problem is aggravated in recent years as more and more, individuals of significantly different cultures and background meet and choose to form a couple. With the appropriate. modifications, the method of the present invention can be used for a couple to formulate a common language for discussion of challenges and in such a way, generate the ability for the couple to communicate.

Prophylactic use of the present invention

It is clear to one skilled in the art that the method of the present invention is not applicable only at a time of crisis nor for the resolution of a specific challenge. A user can apply the method on a regular basis. As Heraclites said, panta rhei, that is all flows. The environment of the user continuously and gradually changes. The regular use of the present invention allows the user to continuously update the mindset. Further, the present invention acts as an early warning system for the user, indicating that an existing mindset is inappropriate to the environment.

The Use of the Present Invention in Performing Remote Discussions

A different embodiment of the present invention allows the performance of remote discussions. In an organization, an applicable issue is formulated and a setting map is made. Thereafter, the participants disperse to remote locations, each with a copy of the setting map. When one or more of the participants encounters a challenge, that participant uses the setting map to understand and relate to the challenge. If the need for deeper interpretation and conceptualization arises, a new brainstorming stage can be initiated. As described above, this may lead to the generation of new knowledge, as expressed in new concepts and in an expansion of the original setting map to form a new setting map. This new setting map can be sent to the other participants who can then review the changes, comment on these changes, integrate these changes or even add new concepts to the setting map as a result of exposure to the new setting maps.

This method of transferring knowledge and discussing new challenges is: superior to what is known in the art. New knowledge and concepts are not just transmitted as such, leaving them open to misinterpretation and misunderstanding. Rather new knowledge and concepts are transmitted within the context that they belong.

The Use of the Present Invention to Catch Ideas

Often an individual has an insight or an idea on some subject when the individual is outside the usual context of the subject. For example, a solution to a problem at work may suddenly come into an individual's mind at a concert. The usual way to react is by writing a note on a piece of paper. When the individual tries to actualize this idea, it is no longer clear what the idea described on the note is. This is a result of the fact that the idea on the note is divorced of the context, including supplementary ideas, which the individual thought of at the moment when the new idea was formulated. Using the -present invention, an individual describes the idea not as a note, but at least one D-space. In this embodiment of the present invention, the individual makes a concept list, the necessary number of D-spaces and a “mini” D-space map containing the D-spaces. At a later time, the person can review the D-space map and understand what the idea was.

A Knowledge Map

In some embodiments of the present invention, the method of the present invention is used to store and present knowledge. The mechanics of the process of storing knowledge is substantially the same as formulating a solution to a challenge: after a D-space map is generated from a concept list using a plurality of D-spaces, the D-space map is summarized and focussed on the issue at hand using a knowledge map.

Although the mechanics of generating a knowledge map are the same as those of generating a setting map, it is important to emphasize the conceptual differences between these two maps.

When formulating a solution to a challenge, the setting map is in fact a summary of the concepts from a mindset which are applicable to the challenge and can be conceived as the preplanning stage in formulating a response to a specific challenge: Once a challenge is met, the setting map loses a large part of its validity. A new challenge will require reformulation of a setting map from the original D-space map. In the case of the setting map the issue posed in preparing the D-space map may be relatively specific and the challenge used is highly specific.

In contrast, when knowledge is stored, the issue used in formulating the D-space map is specific, as can be understood from the example hereinbelow.

A D-Space map is generated as described hereinabove by a professor of management sciences. The issue can be stated as “what is important in managing a large organization”. The use of the D-space map to register and arrange the knowledge is exceptionally advantageous due to the non-linear method of its formation. Throughout a plurality of sessions many concepts and the relation of the concepts to each other can be added. If an important concept is forgotten or escapes attention in earlier sessions, the concept is added at a later date with no adverse effects. Using the structure provided by the present invention, that of a concept list, D-spaces and a D-space map, the professor elicits the knowledge formulated over years of study and contemplation.

The disadvantage of a D-space map is that it is idiosyncratic and unpolished. Since it is a result of brainstorming, Some issues are overemphasized, incomplete ideas are present, the D-space map is disorganized, its contents are insufficiently justified and the D-space map itself is difficult to understand unless it is converged into a knowledge map. Therefore, in the example above, once a D-space map is formulated, the professor generates a knowledge map. Unlike a setting map which is directed at specific challenge, a knowledge map is non-specific and is aimed at summarizing and structuring the important concepts which relate to the issue.

Thus a knowledge map is formulated when convergence of a D-space map is needed without the context of a specific challenge, but more as a generic frame of reference useful in interpreting an issue for understanding future challenges, new information or for familiarizing other individuals with the issue. Thus unlike a setting map, a knowledge map does not lead the user to resolution of a specific issue, but rather graphically represents the knowledge which defines and is useful in understanding the issue. In addition, the tension between two concepts, resulting from the complementary negation is preserved.

In practical terms, a knowledge map is not discarded once an issue is resolved. Rather a knowledge map is preserved as an exposed image of a respective D-space map. The knowledge map can be discussed and used in a brainstorming session to formulate new concepts and to integrate them into the knowledge map. Once integrated into the knowledge map, new concepts can be used to modify a respective D-space map

As is clear to one skilled in the art, it is possible and often advantageous to generate a setting map from an appropriate knowledge map. The process of generating a setting map from a knowledge map is analogous to the process of generating a setting map from a D-space map. Once a challenge is identified, a setting map is constructed based on an appropriate knowledge map as described hereinabove.

Use of a Knowledge Map in Academic Research

The professor of management science formulates a hypothesis as to what the important factors of managing a large organization are. The professor generates a D-space map and from the D-space map, a knowledge map. Thereafter the professor or associates such as peers or students test the knowledge map by assigning a plurality of case studies, each as a challenge. For example, each one of a plurality of students is instructed to test the knowledge map. The case studies offer an opportunity to test and challenge the theory which the knowledge map represents, and stimulate the formulation of changes to the knowledge map. As described above, this may lead to the generation of new knowledge, as expressed in new concepts and in an expansion of the original knowledge trap to form a modified knowledge map. The modified knowledge maps are sent to the professor who can then review the changes, comment on these changes, and choose to integrate these changes into the understanding of the issue by modifying the original D-space map.

Use of a Knowledge Map to Transfer Expert Knowledge

Often, an expert is hired by an organization to transfer knowledge. For example, a large organization may hire the above-mentioned professor to instruct the managers of the organization. Using the present invention, the organization can request that the professor generate a knowledge map for the organization based on the original D-space map of the professor. The knowledge of the expert is then retained by the organization for future reference. It is clear to one skilled in the art, that in the future, the organization can consult with the expert through the common language of a knowledge map.

Use of a Knowledge Map in a New Conceptual Systemic Teaching Method

A knowledge map of the present invention can also be used to teach students complex subjects. Whereas conventional teaching methods are often based on the transfer of content (bits of information and facts), the use of a knowledge map allows the transfer of the concepts that are important in understanding the issue. The students are provided with the skills to create new knowledge in the studied issue. In the example of the professor above, in a lecture the students are exposed to various sections of the knowledge map progressively, and see that interconnection of ideas and concepts therein. The graphic representation of the issue as embodied by the knowledge map allows an intuitive understanding of the issue that is both quick and efficient. An additional bonus is that during the teaching process, questions posed by the students can be discussed in clear terms and may lead to the enrichment and expansion of the knowledge map during the instruction session. This enrichment can later be added to the D-space map on which the knowledge map is based.

Actualization of the method of the present invention

As is clear to one skilled in the art, application of the method of the present invention is difficult due to the large number of concepts and the large number of relationships between the concepts. To manually apply the method of the present invention is virtually impossible. Therefore, the present invention also provides a device for applying the method of the present invention.

In a preferred embodiment, the device of the present invention includes a graphical ;display device such as a computer terminal, an input device such as a mouse and a keyboard, a series of processor commands (a “computer program”, implemented as hardware or software) configured to arrange the information input according to the method of the present invention, and a processor able to accept the input information; to apply the software and to use the display device to show the results graphically. It is most advantageous to have a storage method (e.g. a hard disk) in the device of the present invention.

The use of the device of the present invention is advantageous for a number of reasons:

1. concepts and the connectivity of the concepts can be graphically represented, allowing the human mind to quickly comprehend the relationship of a concept to other concepts;

2. graphic representations of concepts can be hidden from view or displayed at the users convenience and intuitively, for example by using “drag and drop” or mouse-pointing techniques;

3. graphic representations of D-space and setting maps can be rearranged at the users convenience by using “drag and drop” techniques while retaining connectivity, allowing rearrangement of map elements to stimulate cognitive comprehension of a complex structure such as a map;

4. lists and graphic representations which undergo changes can automatically be updated;

5. using geometric forms, scaling, coloring and shading of graphic representations of objects, differences and relationships can be displayed in a way which is intuitively understandable;

6. displaying or graphically emphasizing a specific aspect of an issue in a map and while deliberating allows the user to concentrate attention on the aspect without losing the “big picture”;

7. changes and the history of changes can be recorded, allowing tracing of the evolution of a map;

8. copies of maps can be made and easily stored or transmitted for various purposes, as described hereinabove; and

9. keyword and text searches can be used to case finding related descriptions.

Implementation of the device of the present invention to actualize the above-mentioned advantages is well within the abilities of one skilled in the art. In U.S. Pat. No. 5,506,937 the graphic representation of hierarchical concept maps using a similar device is disclosed. In U.S. Pat. No. 6,031,537, a method and a device for organizing interrelated information and employing a graphical interface to display the information and their network of interrelationships is disclosed.

As is clear to one skilled in the art, there exist many possible specific embodiments of the computer program as well as display and input options. For the purpose of clarification, a non-limiting partial list of possible functionalities realized by the use of the device of the present invention is presented hereinbelow.

First, using the device of the present invention a long list of concepts as well as the descriptions formulated in the D-space map and the setting map can be recorded. Some or all of the concepts or essays can be hidden and displayed at will. The list and essays can be modified using text-processing techniques known in the art.

Second, the use of a computer program simplifies the construction and the comprehension of a D-Space. The triad of concepts within the D-Space is graphically displayed, as depicted in FIG. 2. Each concept is noted inside of an ellipse. The facing arrows connecting the ellipses of two concepts of the triad indicate the complementary negation of these two concepts. The connection of these two concepts using a Y-shaped arrow, indicates the fact that the interaction of these two concepts is considered in the context of the third concept. Using methods known in the art, the device can be configured to display the description associated with any one of the concepts or the triad in an intuitive way. For example, the description associated with the D-Space can be displayed on request by using a mouse input device to “point” at the gray block or one of the ellipses that graphically represent the triad or the concepts, respectively.

Third, construction of a triad within a D-Space is also easily performed. A triad is defined and displayed graphically by indicating the two concepts and the context from the concept list by indicating the three respectively with the help of an input device. The device can immediately graphically display the triad. When building the triad, it is simple to prohibit making any annotation to a concept until the triad is complete. Thus the user is forced to consider a concept exclusively within the framework of a D-space.

Fourth, the automatic generation of a D-space maps from individual D-Spaces is conveniently performed using the device of the present invention. After a D-Space is completed the device easily identifies a concept common to a plurality of D-Spaces and automatically indicates this graphically in the D-Space map.

Fifth, the graphic display of the D-space snap and the setting map allows the human mind to immediately understand the relationship between the concepts. By graphically describing each concept and its connectivity graphically, the device of the present invention allows the mind to quickly comprehend the relationship of a concept to other concepts. Using “drag and drop” techniques, the ellipses representing concepts can be moved without effecting the display of connections to allow the user to arrange the D-space map in a way that is most evocative of the structure of the mindset to the user.

The ability to physically rearrange the graphic representation of the elements of the D-space map gives the user a cognitive advantage in understanding the D-space map.

Sixth, the generation of a setting map based on a D-Space map can also be conveniently performed using the device of the present invention. “Drag and drop” techniques can be used to graphically combine concepts when generating a setting map. The descriptions associated with a connection between concepts in a setting map, or with a concept itself can be associated with the graphic representations thereof, and be displayed, modified or hidden at will. Differentiation or emphasis of parts of the setting snap can be performed by using variations of shading, color and size for the graphic representations that make up the setting map. The ability to physically rearrange and to scale the graphic representation of the elements of the setting map gives the user a cognitive advantage in understanding the setting map.

It is clear to one skilled in the art, that a novice user of the method and device of the present invention may encounter some difficulty as terms such as complementary negation, concepts, and interpreting two concepts in the context of a third. Thus, the present invention also provides for a facilitator. A facilitator is an individual who has experience in applying the method of the present invention and acts to help the user apply the method of the present invention by prompting the user when it is necessary. It is expected that with the time and experience, as the user becomes used to thinking in the manner stimulated by the method of the present invention, the facilitator, becomes less necessary and ultimately the user can autonomously apply the method of the present invention.

In the claims hereinbelow the term “setting map” is to be understood as referring to both a setting map and a knowledge map. Although conceptually and practically different, the two types of map are implemented in a substantially similar way.

It will be appreciated that the above descriptions of the method and the device of the present invention are intended only to serve as examples, and that many other embodiments are possible within the spirit and the scope of the present invention.

1. A device for the generation of a D-space map as a result of a command of a user comprising:
a. a computer device;
b. an input device, configured to input data to said computer device; ;
c. a graphic display device, configured to display data from said computer device;
d. a series of computer instructions useable by said computer device, said instructions configured to cause said computer device to perform at least one of the actions from the group including:
i. displaying a concept list;
ii. generating a D-space from a concept list upon instruction from a user;
iii. forming a D-space map from a plurality of D-spaces;
iv. graphically displaying a D-space map;
v. forming a setting map from a D-space map;
vi. graphically displaying a setting map;
vii. transmitting a setting map to a remote device; and
viii. receiving a setting map from a remote device.

2. A method of storing knowledge comprising
a. providing the device of claim 1; and
b. generating a knowledge map, said knowledge map representing the knowledge.

3. A method of instruction comprising
a. providing the device of claim 1
b. gathering at least one student;
c. displaying a setting map to said at least one student; and
d. explaining said concepts as said concepts appear in said setting map.

4. A method of understanding an issue comprising
a. providing the device of claim 1;
b. gathering at least one individual;-l
c. displaying a D-space map to said at least one individual;
d. discussing the issue, using a framework provided by said D-space; and
e. modifying said D-space map.

5. A method for assisting at least one individual in making a decision
a. providing the device of claim 1;
b. generating a D-space map;
c. generating a setting map; and
d. making the decision.

6. A method of discussing an issue comprising
a. providing the device of claim 1;
b. gathering at least two individuals;
c. generating a D-space map;
d. discussing the issue, using a framework provided by a D-space; and
e. modifying said D-space map.

7. The method of claim 6 further comprising:
f. generating a setting map.

8. A method of discussing an issue when the at least two participants of the discussion are located at at least two physically remote locations comprising
a. providing the device of claim I at each one of the at least two locations;
b. generating a D-space map at one of said at least two locations;
c. generating a setting map from said D-space map at said one of said at least two locations;
d. transmitting said setting map to all of the at least two locations; and then, independently, at each one of the at least two locations:
e. displaying said setting map;
c. modifying said setting map to generate a modified setting map; and
d. transmitting said modified setting map to all of the at least two locations.

9. A method of unifying a mindset of at least two individuals comprising
a. providing the device of claim 1;
b. gathering the at least two individuals;
c. generating a D-space map; and
d. discussing said D-space map.

10. The method of claim 9 further comprising:
e. after said discussing, generating a setting map from said D-space reap.

11. A method of maintaining a unified mindset of at least two individuals comprising
a. providing the device of claim 1;
b. gathering the at least two individuals;
displaying a D-space map; and
d. discussing said D-space map.

12. The method of claim 11 further comprising:
e. after said discussing, generating a setting map from said D-space map.

13. A method for noting an idea
a. providing the device of claim 1; and
b. generating a D-space map, said D-space map describing said idea.

14. A method for generating a D-space map comprising
a. formulating an issue;
b. maintaining a concept list made up of a plurality of concepts;
c. selecting three concepts from said concept list, said three concepts being applicable to said issue;
d. discussing said three concepts within a framework delineated by a D-space; and
e. relating said D-space to at least one additional D-space, said at least one additional D-space pertaining to said issue.

15. A method of storing a mindset comprising
a. providing the device of claim 1; and
b. generating a D-space map, said D-space map representing the knowledge.

16. A method of graphically representing a mindset comprising:
a. providing a graphic display means;
b. generating a D-space map; and
c. displaying said D-space using said graphic display means.

17. A method of graphically representing complementary negation between a first concept, a second concept, and a third concept when the three concepts describe an issue comprising:
a. providing a graphic display means;
b. providing a first term, said first term representing the first concept;
c. providing a second term, said first term representing the second concept;.
d. providing a third term, said first term representing the third concept;
e. displaying said first term and said second term using said graphic display means; and
f. displaying said third term using said graphic display means so as to allow substantial visual differentiation of said third term from said first term and said second term.

18. The method of claim 17 further comprising
g. having a discussion concerning a negation between said first concept and said second concept in the context of said third concept; and
h. graphically displaying a summary of said discussion using said graphic display means.

19. A method of storing an idea comprising:
a. providing a storage means;
b. storing a literal representation of the idea using said storage means;
c. noting a concept list, said concept list made up of a plurality of concepts;
d. generating a D-space map using said concept list; and
e. storing said D-space map using said storage means.

20. A method of reframing a mindset comprising:
a. graphically representing the mindset using a D-space map;
b. systemically discussing the mindset by discussing elements of said D-space map; and
c. modifying said D-space map.
